(19) United States
(12) Patent Application Publication
(10) Pub. No.: US 2023/0097250 A1
(43) Pub. Date: Mar. 30, 2023

(54) FLOTATION SEPARATION UNIT

(71) Applicant: ALLUM TECHNOLOGY AS, Sandefjord (NO)

(72) Inventors: Bjørn Håvard Brænden, Sandefjord (NO); Vegard Klavenes, Sandefjord (NO); Truls Henning Davidsen, Sandefjord (NO); Kåre Klavenes, Sandefjord (NO)

(21) Appl. No.: 17/794,740

(22) PCT Filed: Jan. 22, 2021
(86) PCT No.: PCT/NO2021/050017

§ 371 Date: Jul. 22, 2022

(30) Foreign Application Priority Data
Jan. 22, 2020 (NO) 20200082

(51) Int. Cl. C02F 1/24; B03D 1/02; B03D 1/14; B03D 1/24

(52) U.S. Cl. CPC C02F 1/24; B03D 1/028; B03D 1/1406; B03D 1/1493; B03D 1/247; B03D 2203/006; C02F 2103/10

(57) ABSTRACT

A separation unit for separating contaminants, such as oil, from water comprises at least one inlet section and a separation tank having an outlet for effluent, an outlet for liquid reject, and an outlet for gas. The inlet section comprises an inlet for influent, a gas injector for injecting gas into the influent, a turbulent mixing assembly for mixing the influent and the gas, and a diffuser for reducing a flow velocity of the mixed influent and gas. The separation unit is adapted to control a level of a gas-liquid interface in the tank by regulating leakage of gas using a liquid reject valve in the outlet for liquid reject and/or a gas reject valve in the outlet for gas. The separation unit maintains the level of the liquid interface below an entrance of the outlet for liquid reject during a normal mode of operation, and, during a fluid reject mode of operation, opens the liquid reject valve and raises the level of the liquid interface to be equal to or above the entrance of the outlet for liquid reject.

### TECHNICAL FIELD

The present invention relates to a compact separation unit for liquid-liquid or solid-liquid separation by flotation. The invention also relates to a method for operating the separation unit.

### BACKGROUND

In the oil & gas and shipping industries, enormous quantities of water containing hydrocarbons are produced. This contaminated water needs to be treated before being released to the environment. Norwegian North Sea regulations require the treatment of produced water to less than 30 ppm oil before release into the sea. International regulations on oily bilge water release from vessels require less than 15 ppm oil in water. Some local regulations are even more stringent. Separation by flotation is frequently used as a polishing stage before such release, often following an initial treatment such as hydro-cyclones.

Efficiency of a flotation separation unit can be measured in terms of degree of the removal of contaminants. However, efficiency can also be measured in terms of the volume of fluid rejected as a percentage of the inlet volume, i.e. the quantity of by-product that has been separated in the flotation process (oil or highly concentrated oil in water extracted from the flotation, also called reject volume). The by-products of flotation separation are very costly to process further, either by dedicated treatment or by transport onshore. Consequently, high flotation efficiency is critical. If the reject volume percentage is high, indicating that a significant quantity of water has been captured together with the separated oil, transport to land will be expensive, and the aqueous oily product may require further processing before it can be accepted by refineries.

There is a need for a flotation process producing reject products having a high concentration of contaminants, having high efficiency of treatment, especially for lightly contaminated influent, and for which operation is robust.

There is also a need for a compact flotation in order to fit the restricted space available on an offshore installation or a plant.

At least the preferred embodiments of the present invention seek to fulfil these requirements.

### SUMMARY OF THE INVENTION

Viewed from a first aspect, the present invention provides a separation unit for separating contaminants from water, where the contaminants are suitable for separation by gas-aided flotation, the separation unit comprising a separation tank, an inlet for influent comprising the water and the contaminants, a gas injector for injecting gas into the influent, an outlet for effluent, an outlet for liquid reject, and an outlet for the gas, wherein the separation unit, under operation, includes in the tank a gas cushion and a gas-liquid interface, characterised in that the separation unit comprises a gas-liquid interface level measurement device, the outlet for liquid reject comprises a liquid reject valve, and the outlet for the gas comprises a gas reject valve, wherein the separation unit is adapted to control a level of the gas-liquid interface in the tank by regulating leakage of gas at the liquid reject valve and/or the gas reject valve.

The described system uses a pressurised separation tank when performing flotation separation, which differs from conventional systems that are typically performed at atmospheric pressure. The described flotation separation unit provides a highly stable liquid-gas interface, which permits more efficient removal of contaminants from the separation tank, thereby reducing the reject volume percentage.

Optionally, the separation unit may be configured to maintain the level of the liquid interface below an entrance of the outlet for liquid reject during a normal mode of operation, and to open the liquid reject valve and to raise the level of the liquid interface to be equal to or above the entrance of the outlet for liquid reject during a fluid reject mode of operation.

This permits batch-like removal of the contaminants from the separation tank, which differs from existing systems that perform continuous skimming of the contaminants. By performing batch-like removal, a relatively thick layer of contaminants may be permitted to accumulate within the tank, such that when the contaminants are removed, the reject fluid will have a high concentration of contaminant. This significantly reduces the reject volume percentage of the separation unit.

It has been found that, where the gas-liquid interface is relatively stable, the accumulation of a relatively thick layer of contaminants does not result in an increase of contaminants in the effluent.

The separation unit may comprise a plate installed inside the tank and configured to deflect the gas-liquid interface towards the entrance of the liquid reject outlet as the gas-liquid interface rises. The plate therefore serves to collect the contaminant layer and direct it towards the outlet, further increasing the concentration of contaminants in the reject fluid. The plate may also serve to reduce the risk of the contaminants foaming up towards to gas outlet, where they could interfere with correct operation of the gas outlet valve.

The separation unit may comprise a timer, and may be configured to automatically control start of the fluid reject operation and/or a duration of the fluid reject operation. Alternatively, or additionally, the outlet for liquid reject may comprise a sensor for in-line measurement of a composition of the liquid reject, and the separation unit may be configured to control a duration of the fluid reject operation based on a measurement from the sensor.

The separation unit may comprise an inlet section including the inlet for the influent, and the gas injector for injecting the gas into the influent, wherein the inlet section is configured to supply the mixed influent and gas into the separation tank.

It has been found that by mixing the gas and influent prior to injection into the separation tank, the flow within the separation tank is less turbulent, which permits more efficient gas-liquid separation and also assists in maintaining a stable gas-liquid interface. This differs from conventional flotation separators, which inject the gas into the influent within the tank itself.

Optionally, the inlet section may further comprise: a turbulent mixing assembly for mixing the influent and the gas; and/or a diffuser downstream of the turbulent mixing assembly for reducing a flow velocity of the mixed influent and gas.

The used of a turbulent mixing assembly causes high energy mixing of the gas and influent, resulting in a high degree of coalescence between the gas and contaminants. This means that the contaminants can be easily separated from the influent by gas-liquid separation, thereby allowing for significantly higher separation speed than conventional flotation separation units that bubble the gas into the influent within the tank because bubbling the gas through the influent results in fewer, large gas bubbles and a relatively low degree of mixing.

The use of a subsequent diffusor reduces turbulence of the fluid entering the separation tank, which provides advantages as discussed above. It also recovers fluid pressure, which may avoid the need to re-pressurise the fluid later.

The inlet section may be configured to supply the mixed influent and gas at least partially tangentially into the separation tank, for example so as to generate a vortex with the separation tank. This arrangement further reduces turbulence within the tank, providing advantages as discussed above.

The separation tank may comprise a plurality of baffles configured to form a serpentine flow path between the inlet for the influent and the outlet for the effluent, and the serpentine path may comprising a plurality of substantially vertical flow paths that may each be exposed to the gas cushion.

The use of baffles again helps to maintain laminar flow within the tank.

Furthermore, the use of baffles extends the vertical flow length that can be used for separation, increasing separation efficiency.

The separation unit may be configured to supply a chemical treatment agent to the influent before it enters the separation tank.

The separation unit may comprise at least one of a computer and a PLC for controlling operation of the separation unit. For example, the computer or PLC may receive data from any one or more of the gas-liquid interface measurement device, the timer and the sensor, and may control operation of any one or more of the gas outlet valve and the liquid reject outlet valve.

Viewed from a second aspect, the present invention provides a method of performing a liquid reject operation in the separation unit of any preceding claim, comprising: determining an elevated level for the liquid interface level; controlling the gas reject valve to reduce a pressure of the gas cushion until the gas-liquid interface reaches the elevated level; opening the liquid reject valve to permit outlet of liquid at the gas-liquid interface; closing the liquid reject valve a period of time after opening the liquid reject valve; determining a reduced level for the liquid interface level; and controlling the gas reject valve to increase a pressure of the gas cushion until the gas-liquid interface reaches the reduced level.

This method permits a batch-like removal of the contaminants from the separation tank, providing benefits as discussed above.

The separation unit may continue to emit effluent via the outlet for effluent during the liquid reject operation. This advantageously means that the batch-like removal of contaminants does not require interruption of the separation process. This is possible because the method simply raises the gas-liquid interface, but the gas-liquid separation still continues due to the gas buoyancy.

In the method, the elevated level may be above a lower edge of the plate, and the reduced level may be below the lower edge of the plate. Thus, the liquid isolates the upper region of the tank into two parts, one connected to the gas outlet valve, and one connected to the liquid reject outlet valve. The gas outlet valve can then regulate the gas-liquid interface level within this region, whilst the gas-liquid region on the side of the liquid reject outlet valve can be permitted to continue to elevate in order to evacuate the contaminants.

Viewed from a third aspect, the present invention provides a separation unit for separating contaminants from water, where the contaminants are suitable for separation by gas-aided flotation, the separation unit comprising a separation tank, an inlet for influent comprising the water and the contaminants, a gas injector for injecting gas into the influent, an outlet for effluent, an outlet for liquid reject, and an outlet for the gas, characterised in that the separation unit comprises an inlet section including the inlet for the influent and the gas injector for injecting the gas into the influent, wherein the inlet section is configured to supply the mixed influent and gas into the separation tank.

As discussed above, it has been found that by mixing the gas and influent prior to injection into the separation tank, the flow within the separation tank is less turbulent, which permits more efficient gas-liquid separation and also assists in maintaining a stable gas-liquid interface. This differs from conventional flotation separators, which inject the gas into the influent within the tank itself.

The inlet section may further comprise: a turbulent mixing assembly for mixing the influent and the gas; and/or a diffuser downstream of the turbulent mixing assembly for reducing a flow velocity of the mixed influent and gas.

The inlet section may be configured to supply the mixed influent and gas at least partially tangentially into the separation tank, for example so as to generate a vortex with the separation tank.

The separation unit may comprising a gas-liquid interface level measurement device, the outlet for liquid reject may comprises a liquid reject valve, and the outlet for the gas may comprises a gas reject valve, The separation unit may be adapted to control a level of the gas-liquid interface in the tank by regulating leakage of gas at the liquid reject valve and/or the gas reject valve.

The separation tank may comprise a plurality of baffles configured to form a serpentine flow path between the inlet for the influent and the outlet for the effluent, and the serpentine path may comprising a plurality of substantially vertical flow paths that may each be exposed to the gas cushion.

The inlet section may be configured to supply a chemical treatment agent to the influent.

### BRIEF DESCRIPTION OF THE DRAWINGS

Embodiments of the present invention are described in more details with reference to the illustrative and schematic drawings, which are provided by way of example only, and in which:

FIG. 1 is a schematic section of a first separation unit;

FIGS. 2a and 2b are, respectively, a side view and a vertical section of a second separation unit;

FIGS. 3a and 3b are schematic view of two steps of the rejected liquid extraction in the first separation unit; and

FIG. 4 is an interpolation curve of oil reduction performance test data.

### DETAILED DESCRIPTION OF EXEMPLARY EMBODIMENTS

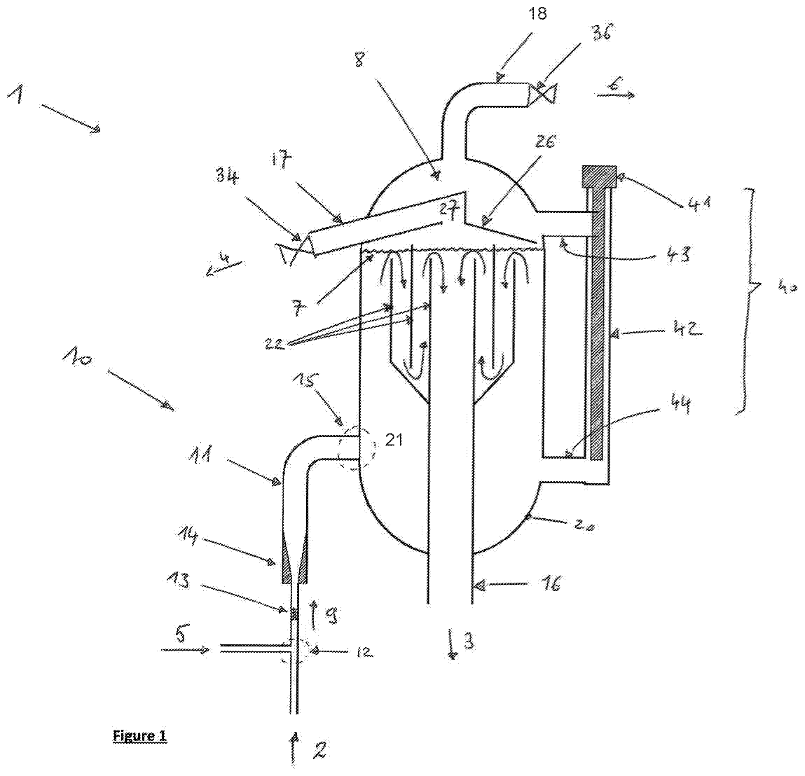

A first separation unit 1 is represented in FIG. 1.

The separation unit 1 comprises at least one inlet pipe section 10 connected to a separation tank 20 having an effluent outlet 16, a reject liquid outlet 17, and a gas outlet 18.

A contaminated, liquid influent 2 is led to the at least one inlet pipe section 10 of the separation unit 1, where it will be subjected to gas injection 12. In one, non-limiting embodiment, the influent 2 may be supplied at a velocity of at least 4 m/s, and typically between 5 and 8 m/s, and at a volume flow rate of between 100 and 500 m³/hour. In various embodiments, higher or lower flow rates may be used.

The influent 2 is typically water of varying salinity. In one embodiment, the influent 2 is oil-contaminated water from oil production. The influent 2 then comprises an emulsion of oil in water. The influent 2 may also contain a small quantity of gas. In some embodiments, the influent 2 can comprise various particles, fibres, polymers, flocs, grease and other contaminants suitable to be separated by flotation, transported in a liquid. In some embodiments, the influent has been submitted to a preliminary chemical treatment, such as by one or more of a coagulant, a flocculant, and an emulsifier.

At the upstream end of the inlet pipe section 10, a gas 5 is injected into the influent 2, by a gas injector 12. The gas injector 12 may comprise a Venturi injector, an injector of gas under pressure, or by any other means known in the art for injecting gas in a circulating liquid. A pressurised influent 9 is then produced, for example injected gas entrained within oil-contaminated oilfield water. The gas 5 may comprise any suitable gas for flotation separation, such as air, nitrogen, and natural gas.

In some embodiments, and still in the inlet pipe section 10, the pressurised influent 9 passes through a turbulent mixing assembly 13 designed to generate strong local turbulences, with fluid shear forces producing more and smaller gas bubbles. These will multiply contact between gas bubbles and oil droplets and produce coalesced, lower density contaminants, which will separate faster.

In an embodiment, the assembly 13 is a flow restrictor, i.e. a local reduction of the internal diameter in the inlet pipe section. A brutal decrease in diameter in turn increases speed and turbulences. In other embodiments, the assembly 13 can be an orifice plate, a calibrated nozzle, or any static mixer suitable for the purpose.

In some embodiments, and still in the inlet pipe section 10, the pressurised influent 9 flows into a diffusor 14, to reduce fluid velocity and regain pressure. This has a double advantage. It reduces the head-loss of the unit and may even save an additional pumping stage upstream or downstream, and by reducing fluid velocity, it favours a smoother flow of the fluid at the inlet in the separation tank.

In a preferred embodiment, the diffusor 14 is installed downstream of the turbulent mixing assembly 13. In some embodiments, the diffusor 14 is a pipe section with an internal conical opening. The opening angle is selected with regard to several parameters including head-losses, a small angle reduces head-loss, available length in the inlet pipe section, and production costs. In preferred embodiments, the angle of the cone is in a range of 2° to 40°, preferably in a range of 2° to 10°.

In some embodiments, not illustrated, the influent 2 is treated with chemicals before gas injection. Such chemicals may be coagulants, flocculants, emulsifiers, which purpose are to modify the contaminants physical and/or chemical characteristics in order to obtain after gas injection coalesced aggregates with better ability to separate in flotation, as known in the art.

In a preferred embodiment, the inlet pipe section 10 is a straight section. It is preferably inclined so that the pressurised influent 9 flows substantially upwards. This limits premature collapse and merging of bubbles. The inclination angle is preferably superior to 45° with respect to horizontal, and even more preferably superior to 85°, for example 90°, i.e. vertical. In this case, the installation is more compact, and the above-mentioned positive effect on bubbles is maximal.

After flowing through the diffusor 14, the pressurised influent 9 enters the separation tank 20 at the tank inlet 15. At this stage, the pressurised influent 9 preferably has a substantially laminar flow. Depending on the geometry selected for the separation unit 1, the inlet pipe section 10 may present a bend, for example after the diffuser 14. In some embodiments, the bend is an approximately 90° bend and connects substantially horizontally to the tank 20. In other embodiments, the inlet to the tank may show a limited angle with the horizontal.

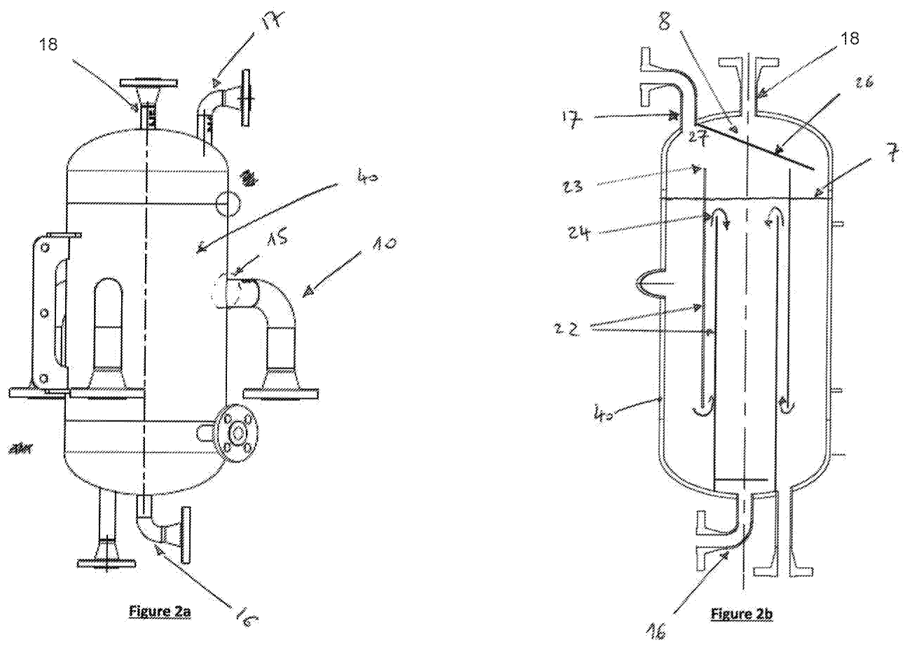

The separation unit 1 may be designed with several inlet pipe sections 10 and tank inlets 15, for example 2, 3, 4 or more inlet pipe sections 10. In such case, after an optional upstream flow distribution in each inlet pipe section 10, as discussed above, the pressurised influent 9 enters the separation tank 20, respectively, via several inlet pipe sections spaced around the tank 20, as illustrated in FIG. 2. Such distribution may be preferred to obtain a more stable and laminar flow within the tank 20. It also provides operational flexibility when there is a significant change of influent flow. For example, in the case of a drastic flow reduction, one or more of the inlet pipe sections 10 may be shut. This modularity may in some embodiments help keeping the flow of influent 2 in the remaining inlet pipe sections 10 in a range ensuring good pre-treatment.

Tank inlet 15 is preferably designed to minimize turbulences within the separation tank 20. In some embodiments, the pressurised fluid enters the tank at least partially tangentially with relation to the tank wall, i.e. with a lateral deviation from a direction perpendicular to the wall of the tank 20. Such deviation may in some embodiments be in the range of 40° to 70°, more preferably in the range of 45° to 65°. In other embodiments, not illustrated, and to achieve less turbulent flow when entering the tank, the ingoing fluid 9 may first enter a buffer chamber distributing the flow in the tank with a shape designed to reduce local velocity and limit turbulence.

In some preferred embodiments, the inflow angle of the tank inlet 15 is designed to create a slowly rotating flow pattern in the separation tank 20, like a vortex.

The tank 20 thus contains a liquid column of flowing, pressurised fluid, and a pressurised gas cushion at a top region 8 of the tank 20, contacting at a gas-liquid interface 7. The inlet pipe section 10 described above has caused coalescence between the gas and the contaminant, such as oil, within the water. Therefore, as the gas bubbles within the water move upwards due to their relative buoyancy, they carry the contaminants with them towards the top of the tank 20. A gas-liquid interface 7 is formed at the top of the pressurised fluid column that is rich with oil. The pressurised fluid 9 enters the tank 20 below the liquid-gas interface 7.

In some embodiments, a plurality of baffles 22 are provided within the tank 20 to guide the flow vertically upwards and downwards. In a preferred embodiment, the baffles 22 are substantially cylindrical and concentric. The number and the dimensions of baffles may vary, and are optimised to maximise separation via stable and if possible laminar flow within the tank 20, preferably in a vertical direction.

In some embodiments, the oil-contaminated water flows via the baffles 22 from the outer diameter of the tank 20 to the inner diameter of the tank 20, where the treated flow runs downwards through the effluent outlet 16 in the centre of the tank 20 and out at the bottom of the tank 20.

In the example of FIG. 1, two baffles 22 are formed around the inlet to the effluent outlet 16 to form a U-shaped flow path. The fluid will initially flow upwards within the tank 20 after entering at the tank inlet 15. An inlet zone 21 of larger radial dimensions than other areas in the tank 20 is provided for stabilising the fluid flow before entering the baffled, more stable flow zone. When the liquid reaches the top of the first baffle 22, it will then flow vertically downwards until it reaches the bottom of the second baffle 22. It will then flow vertically upwards until it reaches the top edge 23 of the effluent outlet 16.

The tank 20 is a pressurised vessel, configured for operation at internal pressures above atmospheric pressure. In various embodiments, the pressure within the tank 20 during operation is at least 1 barg, and preferably between 3 barg and 10 barg. However, higher pressures can be used if desired. In one example, the internal pressure is approximately 6 barg.

The pressure within the tank 20 is typically maintained at an approximately constant pressure, but may vary over time as the inlet pressure changes.

Whilst not shown, the effluent outlet 16 comprises or is connected to a restriction or valve for regulating the flow of effluent 3 out of the tank 20 in order to maintain the internal pressure within the tank 20.

Laminar flow favours separation of the lower density, coalesced contaminant-gas bubbles. In preferred embodiments, the fluid flow pattern in the separation tank 20 is designed for vertical downward water flow between the baffles 22 at a velocity slower than a vertical upward gas velocity, due to buoyancy, such that separation continues to occur between the baffles 22.

The gas cushion pressure regulates the liquid level inside the tank 20. As gas 5 enters the tank 20 together with the influent 2, gas continuously accumulates at the top region 8 of the tank 20. By controlling a rate of release of this gas via the gas outlet 18, the position of the gas-liquid interface 7 can be regulated. In preferred embodiments, the gas cushion will be regulated so as to stabilise the interface 7 at a level where the pressurised fluid within the tank 20 has the required flow pattern. This level, in the case of FIG. 1, is at a position comprised between the lower weir 24 of the external cylindrical baffle 22, and the higher weir 23 of the internal baffle 22. This position defines the optimal flow pattern illustrated by the arrows. Another level position is illustrated on FIG. 2b.

During operation, and as the gas supply to the gas cushion is continuous, gas 6 is leaked at the top of the separation tank 20, for example by means of a gas reject valve 36 provided within gas outlet 18. If the interface 7 moves upwards, such as when the flow of influent 2 to the separation unit 1 increases, the gas leakage rate may be reduced to build-up gas cushion pressure, thus maintaining or lowering the height of the gas-liquid interface 7. This can be done for example by choking the gas reject valve 36, thus favouring retention of gas inside the tank 20 and pressure build-up. In some embodiments, the gas reject valve 36 is a regulation valve, to enable fine-tuning of the leakage.

If, on the other hand, the level of the interface 7 gets lower, as may happen for example if the flow of influent 2 is reduced, the gas leakage rate may be increased, thus reducing the gas cushion pressure, and favouring a level increase. This may be achieved by opening the gas reject valve 36 more.

The gas leakage valve 36 may be controlled by an interface level regulation device 40, as known in the art. In some embodiments, level measurement is made inside the tank 20. In a preferred embodiment, the level regulation device 40 includes a parallel standpipe 42 with level measurement 41. The standpipe 42 may be a vertical pipe parallel to the tank 20. The top of the vertical standpipe 42 is connected 43 to the gas cushion at the top of the tank 40, and the bottom of the standpipe is connected 44 to the bottom of the tank 20. These connections ensure that the liquid level in the tank 20 is reflected in the standpipe 42, hence the level measurement device 41 installed in the standpipe 42 will measure the liquid level in the tank 20. Having a level measurement installed in a parallel standpipe 42 as here described prevents liquid circulation of the oil contaminated flow at the point of level measurement. This solution prevents contamination of the level measurement equipment, assuring robustness over time. In a preferred embodiment, the level regulation sensor is a guided wave radar installed in a parallel standpipe 42.

Valves may be installed on the standpipe 42, for calibration and flushing of the standpipe 42 without interrupting operation of the separation unit 1. For example, when flushing, valves on the top and bottom outlets connecting the standpipe 42 to the tank 20, must be closed. Having these valves closed also facilitates the calibration of the level measurement device 40 in operation.

The contaminants concentrated at the interface 7 inside the tank are evacuated through the fluid reject outlet 17, and by means of control of the gas cushion. Here are some examples of liquid rejecting sequences.

In some embodiments, in order to reject the accumulated contaminants, the gas reject valve 36 is closed, and the fluid reject valve 34 is opened. The gas from the gas cushion is initially expelled through the reject liquid outlet 17 and reject liquid valve 34, and the liquid-gas interface 7 will rise inside the tank 20 towards a false ceiling plate 26 located in the upper part of the tank 20.

The false ceiling plate 26 is surrounded by the gas cushion under normal operation, i.e. when fluid reject is not taking place. The lower surface of the false ceiling plate 26 is angled with respect to horizontal, and is open to the reject liquid outlet 17 at its highest point.

This false ceiling plate 26 prevents the interface 7 or the liquid from reaching the gas leakage valve 36 during normal operation. One or more gaps are provided at the lower edges of the false ceiling plate 26 to permit flow of gas past the false ceiling plate 26 during normal operation, but these preferably represent a small fraction of the cross-sectional area of the tank, such as less than 10% and preferably less than 5%.

As the liquid level rises, the liquid does not further compress the gas due to the pressure balance between gas and liquid, and the interface 7 with its trapped oil is thus channelled towards the liquid reject outlet entrance 17.

To stop fluid reject, the liquid reject valve 34 is closed, and the interface 7 settles back to its required level by control of the gas cushion pressure via control of gas leakage rate, for example at the gas leakage valve 36. In order to build-up the gas cushion, the gas reject valve 36 may be kept closed until the interface level has come back to normal, whereupon the gas reject valve 36 may be reopened for controlled leakage.

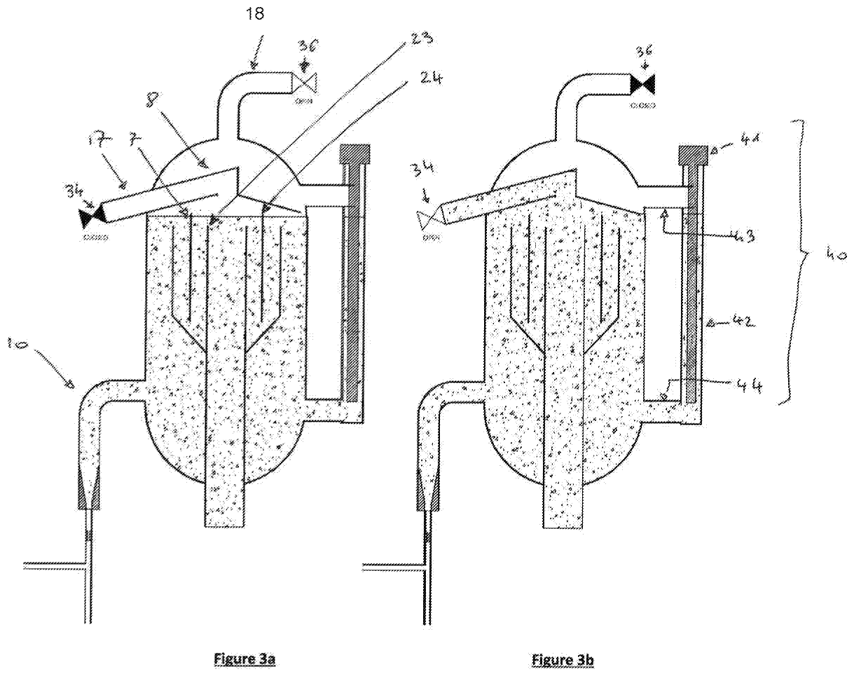

The fluid reject sequence may be as follows, with reference to FIGS. 3a and 3b.

Thanks to controlled reduction of pressure of the gas cushion by increasing the gas leakage rate at the gas leakage valve 36, the interface 7 rises until it reaches the false ceiling plate 26 and/or the liquid reject outlet entrance 27. Then, by opening the liquid reject valve 34 and choking or closing the gas leakage valve 36, the contaminants of the interface 7 flow out of the separation tank 20. Such procedure limits the release of gas at the fluid reject outlet at the beginning of reject, and may provide a better selection of the contaminants to reject, producing less liquid rejects.

In FIG. 3a, opening the gas leakage valve 36 induces a rise of the gas-liquid interface 7. In FIG. 3b, when the interface has reached an entrance 27 of the fluid reject outlet 17, the gas leakage valve 36 closes, the fluid reject valve 34 opens, oil accumulated at the interface is rejected, until fluid reject valve 34 closes again.

In the embodiments described above, controlling the interface position and/or fluid reject occurs whilst separation still is in operation. The influent 2 flows in and separation process continues in the liquid column.

Optionally, these operations are performed while adjusting the effluent flow 3 downstream of the tank 20, so as to have a finer control of the interface 7 and/or the pressure in the tank 20.

In some embodiments, liquid reject occurs at time intervals, in a batch manner. Reject intervals may for example be triggered by a timer, by measurement of the quality of the effluent 3, or by any other measurement such as the thickness of the interface 7. In one embodiment, a dielectric sensor assessing the quantity of oil-in-water of the effluent 3 may for example be used.

A duration of reject process may be controlled by a timer. The timer may be set to switch when the oil-in-water, or more generally the proportion of contaminants decreases under a defined value, as may be controlled manually. The timer setpoint may also be defined after inline measurement of the composition of the liquid reject as a function of reject duration.

In other embodiments, the duration of fluid reject may be controlled by inline measurements of the quality of the reject. A dielectric sensor assessing the quantity of oil-in-water of the reject fluid 4 may for example be used.

It has been observed that this batch mode of operation, even with limited elimination of the oil concentrated at the interface, did not decrease the quality of the effluent 3, while significantly reducing the proportion of liquid that is rejected.

The interface 7 level control and contaminant reject process have been described involving two valves, the liquid or fluid reject valve 34, and the gas reject or leakage valve 36, both installed at a higher end of the tank 20. In some embodiments, a single valve may have the function of controlling both gas leakage and liquid reject.

In the above-described separation unit 1, the inlet pipe section 10 ensures good coalescence between the gas and the contaminants within the water. Consequently, the separation tank 20 only needs to be sized to achieve separation of the gas and the water in order to also separate the contaminant from the water. Furthermore, the use of the above-described inlet pipe section 10 achieves a much higher degree of coalescence between the gas and the oil than in existing flotation separators that simply bubble the gas through the separation tank, as this results in fewer, large gas bubbles that are not vigorously mixed with the influent 2.

The effect of this is that separation occurs very quickly. For example, in some embodiments, the tank 20 may be sized to have an average liquid residence time of less than 100 seconds, preferably less than 60 seconds and most preferably between 10 and 30 seconds. This allows to have a very compact reactor.

Yet further, because the inlet pipe section 10 generates very small gas bubbles and because the separator 1 is configured to maintain a substantially laminar flow within the tank 20, the gas-liquid interface 7 within the tank 20 is very stable, which ensures good separation, even when a relatively large quantity of oil has accumulated at the interface 7.

A single separation unit 1 has been discussed. Multiple such separation units 1 may be installed and used in parallel or in series.

The pressurised fluid flow pattern in the separation tank 20 has herein been described as centripetal, with the pressurised influent 9 entering the separation tank 20 at the tank inlets 15 on the side walls and the treated effluent 3 exiting at the centre of the bottom of the separation tank 20. However, other embodiments may include a separation tank 20 with a centrifugal flow pattern, such that the pressurised influent 9 enters the separation tank 20 at one or several inlets at the bottom of the tank 20 close to its centre, and the treated effluent 3 exits the separation tank 20 via one or several outlets at the side walls of the tank 20.

Operation of the separation unit 1 will preferably be steered by a computer, a PLC, or a combination of those, with all process control units, featuring instrumentation and safety controls, as known in the art.

### EXPERIMENTS

A pilot of the flotation separation unit 1 has been tested on a test rig. The inlet fluid 3 was produced from North Sea water and North Sea oil. The gas used was nitrogen. A flocculant marketed for slop treatment was also used in some of the tests. The oil content was measured by fluorescence Fluorocheck, and oil droplet size were measured using a Malvern particle analyser.

The pilot was operated according to procedures described in this patent description, with batch extraction.

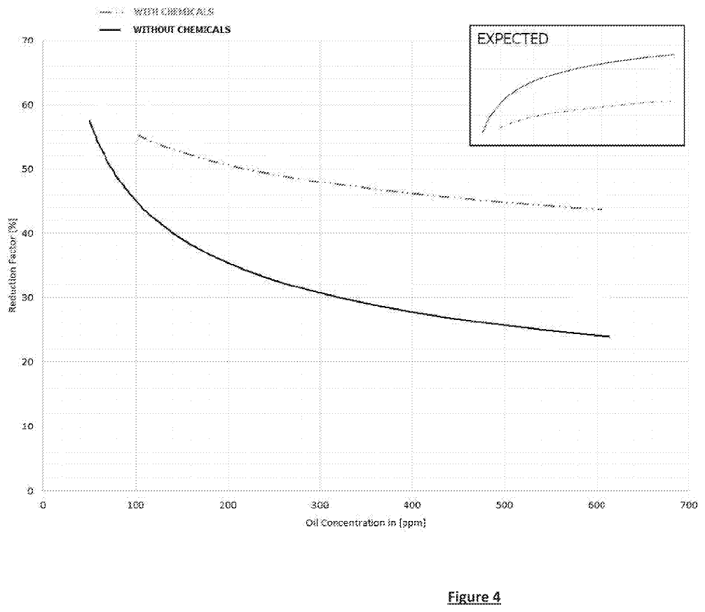

Efficiency measured in terms of reduction factor % was plotted against influent oil concentration ppm, see FIG. 4. In the case of gas nitrogen-saturated water, treatment efficiency improved for lower oil content in the case of nitrogen. This was a surprising observation, as it is generally observed that the reduction factor decreases with low influent oil concentrations.

For two of the operating days, a rough calculation of the reject percentage was made, and the results were 0,21% and 0,16%. Test report comments: «tests performed 18 and 19 has shown that the reject can be emptied after long intervals for low oil concentration 100 ppm without performance loss. Then, the reject flow liquid can be lowered to at least below 0,1%».

A reject percentage of 0.2 to 0.1% is a surprising value, far below the figures observed in the industry, which are in terms of several percentage points.

It was also observed that accumulation of oil at the interface 7, i.e. by increasing the interval between the batch liquid reject processes did not affect the contaminant reduction factor, i.e. the quantity of contaminant removed from the influent 2 by the separation unit 1.

### CLAUSES

The following clauses set out examples, which may or may not presently be claimed, but which may provide basis for future amendments or a divisional application.

1. A separation unit (1) for separating contaminants from water, where the contaminants are suitable for separation by gas-aided flotation, the separation unit comprising a separation tank (40) an inlet for the influent (10), means for injecting gas in the influent (5), an outlet for the effluent (16), an outlet for the liquid reject (17) with a valve (34), and characterised in that the separation unit (1) under operation includes in the tank (40) a gas cushion (8) and a gas-liquid interface (7), and comprises a gas-liquid interface level measurement device (40) and an outlet for the gas reject (16) with a valve (36) at a higher end of the tank (40) wherein the liquid-gas interface level measurement device (40) is adapted to control the position of the gas-liquid interface (7) in the tank by regulating leakage of gas at the gas reject valve (36) and/or the fluid reject valve (34).

2. A separation unit of clause 1, wherein additional means for treating the influent (2) before entering the separation tank (1, 15) comprise chemical treatment, a flow restriction (13) and a flow diffusor (14).

3. A separation unit of clause 1, wherein the gas-liquid interface level can be risen to a fluid reject entrance (17, 27) thus enabling fluid reject by opening the fluid reject valve (34).

4. A separation unit of clause 1, wherein an internal false ceiling plate (26) installed in the upper end inside the tank (40) deflects the gas-liquid interface (7) towards the liquid reject outlet entrance (27, 17) and prevents the interface (7) from reaching the gas reject outlet (16).

5. A separation unit of clause 1, wherein a timer may controls start of the fluid reject extraction phase and optionally the duration of such extraction phase.

6. A separation unit of clause 1, comprising in addition at least a computer or a PLC for steering the separation unit.

7. A method of performing a liquid reject in the separation unit (1) of clause 1, wherein a new setpoint is defined for the gas liquid interface level (7), the measure provided by the gas-liquid interface level measurement device (40) is compared with the set-point and the gas leakage in modified in order to bring the measured gas-liquid interface level to the set-point range, when the gas-liquid interface has reached its fluid reject setpoint, the fluid reject valve (34) opens, and when the fluid reject duration time has lapsed, or when the fluid reject reaches a predefined quality, the fluid reject valve (34) closes.

### LIST OF REFERENCE NUMERALS

1. separation unit

2. Influent, fluid to treat, oil-contaminated water with or without gas

3. Effluent, treated liquid

4. fluid reject, liquid reject

5. pressurising gas

6. reject gas, leaked gas

7. interface, gas-liquid interface

8. gas cushion

9. pressurised influent

10. inlet pipe section

11. inlet pipe

12. gas injection

13. restriction

14. diffusor

15. tank inlet

16. effluent outlet

17. liquid reject outlet, fluid reject outlet

18. gas outlet, gas leakage outlet

20. tank

21. inlet zone

22. baffles

23. higher weir

24. lower weir

25. effluent zone

26. false ceiling plate, plate

27. reject zone, reject outlet entrance

32. reject fluid valve, reject liquid valve

36. reject gas valve, leakage gas valve

40 interface level measurement

41 level sensor, level transmitter

42 stand-pipe

43. higher stand-pipe connection to tank

44. lower stand-pipe connection to tank

1. A separation unit (1) for separating contaminants from water, where the contaminants are suitable for separation by gas-aided flotation, the separation unit comprising a separation tank (20), an inlet for influent (2) comprising the water and the contaminants, a gas injector for injecting gas into the influent (5), an outlet for effluent (16), an outlet for liquid reject (17), and an outlet for the gas (18), wherein the separation unit (1), under operation, includes in the tank (20) a gas cushion (8) and a gas-liquid interface (7),
characterised in that the separation unit (1) comprises a gas-liquid interface level measurement device (40), the outlet for liquid reject (17) comprises a liquid reject valve (34), and the outlet for the gas (18) comprises a gas reject valve (36), wherein the separation unit (1) is adapted to control a level of the gas-liquid interface (7) in the tank (20) by regulating leakage of gas at the liquid reject valve (34) and/or the gas reject valve (36).

2. A separation unit (1) according to claim 1, wherein the separation unit (1) is configured to maintain the level of the liquid interface (7) below an entrance (27) of the outlet for liquid reject (17) during a normal mode of operation, and wherein the separation unit (1) is configured to open the liquid reject valve (34) and to raise the level of the liquid interface (7) to be equal to or above the entrance (27) of the outlet for liquid reject (17) during a fluid reject mode of operation.

3. A separation unit (1) according to claim 2, comprising a plate (26) installed inside the tank (40) and configured to deflect the gas-liquid interface (7) towards the entrance (27) of the liquid reject outlet (17) as the gas-liquid interface (7) rises.

4. A separation unit (1) according to claim 2 or 3, comprising a timer, wherein the separation unit (1) is configured to automatically control start of the fluid reject operation and/or a duration of the fluid reject operation.

5. A separation unit (1) according to claim 2 or 3, wherein the outlet for liquid reject comprises a sensor for in-line measurement of a composition of the liquid reject, and wherein the separation unit (1) is configured to control a duration of the fluid reject operation based on a measurement from the sensor.

6. A separation unit (1) according to any preceding claim, comprising an inlet section including the inlet for the influent (2), and the gas injector for injecting the gas into the influent (5), wherein the inlet section is configured to supply the mixed influent (2) and gas (5) into the separation tank (20).

7. A separation unit (1) according to any preceding claim, wherein the inlet section further comprises:
a turbulent mixing assembly (13) for mixing the influent (2) and the gas (5); and
a diffuser (14) downstream of the turbulent mixing assembly for reducing a flow velocity of the mixed influent (2) and gas (5).

8. A separation unit according to claim 6 or 7, wherein the inlet section is configured to supply the mixed influent (2) and gas (5) at least partially tangentially into the separation tank (20) so as to generate a vortex with the separation tank (20).

9. A separation unit (1) according to any preceding claim, wherein the separation tank (20) comprises a plurality of baffles configured to form a serpentine flow path between the inlet for the influent (2) and the outlet for the effluent (16), the serpentine path comprising a plurality of substantially vertical flow paths that are each exposed to the gas cushion.

10. A separation unit according to any preceding claim, wherein the separation unit (1) is configured to supply a chemical treatment agent to the influent (2) before it enters the separation tank (20).

11. A separation unit (1) according to any preceding claim, comprising at least one of a computer and a PLC for controlling operation of the separation unit (1).

12. A method of performing a liquid reject operation in the separation unit (1) of any preceding claim, comprising:
determining an elevated level for the liquid interface level (7);
controlling the gas reject valve (36) to reduce a pressure of the gas cushion until the gas-liquid interface (7) reaches the elevated level;
opening the liquid reject valve (34) to permit outlet of liquid at the gas-liquid interface (7);
closing the liquid reject valve (34) a period of time after opening the liquid reject valve (34);
determining a reduced level for the liquid interface level (7); and
controlling the gas reject valve (36) to increase a pressure of the gas cushion until the gas-liquid interface (7) reaches the reduced level.

13. A method according to claim 12, wherein the separation unit (1) continues to emit effluent via the outlet for effluent (16) during the liquid reject operation.

14. A method according to claim 12 or 13, when dependent upon claim 3, wherein the elevated level is above a lower edge of the plate (26), and wherein the reduced level is below the lower edge of the plate (26).

15. A separation unit (1) for separating contaminants from water, where the contaminants are suitable for separation by gas-aided flotation, the separation unit comprising a separation tank (20), an inlet for influent (2) comprising the water and the contaminants, a gas injector for injecting gas into the influent (5), an outlet for effluent (16), an outlet for liquid reject (17), and an outlet for the gas (18), characterised in that the separation unit (1) comprises an inlet section including the inlet for the influent (2) and the gas injector for injecting the gas into the influent (5), wherein the inlet section is configured to supply the mixed influent (2) and gas (5) into the separation tank (20).

16. A separation unit (1) according to claim 15, wherein the inlet section further comprises:
a turbulent mixing assembly (13) for mixing the influent (2) and the gas (5); and
diffuser (14) downstream of the turbulent mixing assembly for reducing a flow velocity of the mixed influent (2) and gas (5).

17. A separation unit according to claim 15 or 16, wherein the inlet section is configured to supply the mixed influent (2) and gas (5) at least partially tangentially into the separation tank (20) so as to generate a vortex with the separation tank (20).

18. A separation unit according to any of claims 15 to 17, comprising a gas-liquid interface level measurement device (40), wherein the outlet for liquid reject (17) comprises a liquid reject valve (34), and the outlet for the gas (18) comprises a gas reject valve (36), wherein the separation unit (1) is adapted to control a level of the gas-liquid interface (7) in the tank (20) by regulating leakage of gas at the liquid reject valve (34) and/or the gas reject valve (36).

19. A separation unit (1) according to any of claims 15 to 18, wherein the separation tank (20) comprises a plurality of baffles configured to form a serpentine flow path between the inlet for the influent (2) and the outlet for the effluent (16), the serpentine path comprising a plurality of substantially vertical flow paths that are each exposed to the gas cushion.

20. A separation unit according to any of claims 15 to 19, wherein the inlet section (10) is configured to supply a chemical treatment agent to the influent (2).
